(19) United States
(12) Patent Application Publication
(10) Pub. No.: US 2014/0137874 A1
(43) Pub. Date: May 22, 2014

(54) HEEL ELEVATING POSITIONER

(71) Applicant: Span-America Medical Systems, Inc., Greenville, SC (US)

(72) Inventor: James R. O'Reagan, Greer, SC (US)

(73) Assignee: Span-America Medical Systems, Inc., Greenville, SC (US)

(21) Appl. No.: 14/060,754

(22) Filed: Oct. 23, 2013

Related U.S. Application Data
(60) Provisional application No. 61/727,359, filed on Nov. 16, 2012.

(51) Int. Cl. A61G 7/075

(52) U.S. Cl. CPC A61G 7/0755
USPC 128/845

(57) ABSTRACT

A heel elevating positioner is provided. The heel elevating positioner includes a foam block. The foam block includes a top surface having a curved portion or curved top edge. Such features can assist with supporting a leg of a patient and hinder dropping or rotation of an associated foot and toes.

### PRIORITY CLAIM

This application claims the benefit of previously filed U.S. Provisional Patent Application entitled “HEEL ELEVATING POSITIONER,” assigned U.S. Ser. No. 61/727,359, filed Nov. 16, 2012, and which is incorporated herein by reference for all purposes.

### FIELD OF THE SUBJECT MATTER

The presently disclosed subject matter relates generally to supports for elevating and positioning legs and heels, and more particularly relates to assisting with support of a leg of a patient while tending to prevent drop or rotation of an associated foot and toes.

### BACKGROUND OF THE SUBJECT MATTER

Elevating legs of a patient can facilitate healing of certain leg injuries or conditions. In particular, elevating legs of patients with decreased or insufficient circulation can facilitate healing and speed recovery by stimulating or increasing blood flow. For example, elevating legs can facilitate healing after orthopedic or venous surgery and can also facilitate treatment of pressure ulcers.

To assist with elevating legs, various leg positioners are available. Some previously provided leg positioners have been generally wedge shaped foam blocks configured for supporting legs on a top surface of the foam block. However, such foam blocks can suffer from several limitations and drawbacks.

As an example, pressure ulcers can develop when bone protuberances rest on a foam block for extended periods of time. In particular, pressure ulcers commonly develop on patients' heels when the more projecting features of their heels are in prolonged contact with the foam block's top surface. To avoid such injuries, a patient's legs may be generally positioned so that their Achilles tendons rest on an edge of the foam block and with their heels hanging off the foam block. However, the foam block's typically square edge can apply pressure to the Achilles tendon when it rests on the edge of the foam block. Such pressure can be uncomfortable or painful. Further, such pressure can cause the patient's foot and toes to drop downwardly (that is, away from the patient's head). In turn, such movement can place the patient's heel in contact with the foam block, and pressure sores can develop due to such contact.

Accordingly, an improved heel elevating positioner with features for supporting a leg of a patient would be useful. In particular, a heel elevating positioner with features for hindering dropping of a foot and associated toes supported thereon would be useful. In addition, a heel elevating positioner with features for hindering rotation of a foot supported thereon would be useful.

A leg resting on foam block can also experience shear stress and friction forces. Shear stress and friction can cause patient discomfort, hinder healing and/or detrimental impact or damage to a patient's skin condition and/or associated underlying circulation. Accordingly, a heel elevating positioner with features for reducing friction forces and/or shear stress between a patient's leg and the heel elevating positioner would be useful.

### BRIEF DESCRIPTION OF THE SUBJECT MATTER

The presently disclosed subject matter recognizes and variously addresses the foregoing issues, and others concerning certain aspects of heel elevating positioners. Thus, broadly speaking, an object of certain embodiments of the presently disclosed subject matter is to provide improved designs for heel elevating positioners. More particularly, the presently disclosed subject matter provides a heel elevating positioner. The heel elevating positioner includes a foam block. The foam block includes a top surface having a curved portion or curved top edge. Such features when properly utilized in accordance with presently disclosed subject matter can assist with supporting a leg of a patient while tending to prevent drop or rotation of an associated foot and toes. Additional aspects and advantages of the presently disclosed subject matter will be set forth in part in the following description, or may be apparent from the description, or may be learned through practice of the presently disclosed subject matter.

In a first exemplary embodiment, a heel elevating positioner is provided. The heel elevating positioner may define a vertical direction, a lateral direction, and a transverse direction. The vertical, lateral, and transverse directions may be mutually perpendicular. The heel elevating positioner may include a foam block having a top surface configured for supporting a leg thereon and a bottom surface. The top and bottom surfaces may be spaced apart from each other along the vertical direction. The top surface may extend between a first end portion and a second end portion along the transverse direction. The top surface may have a planar portion positioned adjacent the first end portion of the top surface and a curved portion positioned adjacent the second end portion of the top surface.

In another presently disclosed exemplary embodiment, the planar portion of the top surface and the bottom surface may define an angle therebetween, e.g., in a plane that is perpendicular to the lateral direction. The angle can be between about ten degrees and about thirty degrees.

In another presently disclosed exemplary embodiment, the first and second end portions of the top surface have respective vertical heights. The second end portion vertical height may be greater than the first end portion vertical height.

In another presently disclosed exemplary embodiment, the top surface of the foam block has a top edge on the curved portion of the top surface. The top edge is positioned between the first end portion of the top surface and the second end portion of the top surface along the transverse direction.

In still another presently disclosed exemplary embodiment, the heel elevating positioner can include a cover mounted over the foam block. The cover can be constructed of a water resistant material. A slip (or movable internal layer) can be positioned between the top surface of the foam block and the cover along the vertical direction. The slip can be constructed of nylon and be configured for reducing shear forces between a leg resting on the top surface of the foam block and the foam block or for reducing friction between the foam block and the cover.

In another presently disclosed exemplary embodiment, the foam block may define a plurality of channels at the top surface of the foam block. The channels of the plurality of channels can extend along the lateral direction.

In another presently disclosed exemplary embodiment, the foam block may include a plurality of supports positioned at the top surface of said foam block and extending along the lateral direction. Each support of the supports can have a distal end portion with a substantially semicircular cross-sectional area in a plane that is perpendicular to the lateral direction.

In yet another presently disclosed exemplary embodiment, the foam block includes a first foam portion that defines the top surface of the foam block and a second foam portion that defines the bottom surface of the foam block. The second foam portion may be positioned below the first foam portion along the vertical direction. The second foam portion of the foam block can have a greater density than the first foam portion of the foam block.

In a second exemplary embodiment, a heel elevating positioner is provided. The heel elevating positioner may define a vertical direction, a lateral direction, and a transverse direction, which may be mutually perpendicular. The heel elevating positioner may include a foam block having a top surface configured for supporting a leg thereon and a bottom surface. The top surface may extend between a first end portion and a second end portion along the transverse direction. The first end portion and the second end portion each have respective, vertical heights. The top surface also may have a top edge positioned between the first and second end portions along the transverse direction. The top edge may have a curved profile in the plane that is perpendicular to the lateral direction.

In a third exemplary embodiment, a heel elevating positioner is provided. The heel elevating positioner may include a foam block having support means for hindering rotation of a heel supported on the foam block.

In another presently disclosed exemplary embodiment, the heel elevating positioner can also include a cover mounted over the foam block and means for reducing friction between the cover and the foam block.

Those of ordinary skill in the art will understand from the complete disclosure herewith that the presently disclosed subject matter equally relates to apparatus as well as to corresponding and/or associated methods.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 provides a perspective view of a heel elevating positioner according to an exemplary embodiment of the presently disclosed subject matter;

FIG. 2 provides a perspective view of the heel elevating positioner of FIG. 1 with a cover of the heel elevating positioner removed to reveal a foam block of the heel elevating positioner;

FIG. 3 provides a section view of the heel elevating positioner of FIG. 1 taken along the section line 3-3 of FIG. 1 and shows a slip of the heel elevating positioner disposed between the cover and the foam block;

FIG. 4 provides a side, elevation view of the heel elevating positioner of FIG. 1 and shows the slip of the heel elevating positioner positioned over a top surface of the foam block;

FIG. 5 provides a front, elevation view of the slip of the heel elevating positioner of FIG. 4 positioned on the top surface of the foam block; and

FIG. 6 provides a perspective view of the heel elevating positioner of FIG. 1 with a leg supported thereon.

FIG. 7 provides a section view of the heel elevating positioner of FIG. 1 and shows a leg supported thereon.

Repeated use of reference characters throughout the present specification and appended drawings is intended to represent same or analogous features, elements, or steps of the presently disclosed subject matter.

### DETAILED DESCRIPTION OF THE SUBJECT MATTER

Reference is made herein in detail to embodiments of the presently disclosed subject matter, one or more examples of which are illustrated in the drawings. Each example is provided by way of explanation of the presently disclosed subject matter, not limitation of the presently disclosed subject matter. In fact, it will be apparent to those skilled in the art that various modifications and variations can be made in the presently disclosed subject matter without departing from the scope or spirit of the presently disclosed subject matter. For instance, features illustrated or described as part of one embodiment can be used with another embodiment to yield a still further embodiment. Thus, it is intended that the presently disclosed subject matter covers such modifications and variations as come within the scope of the appended claims and their equivalents.

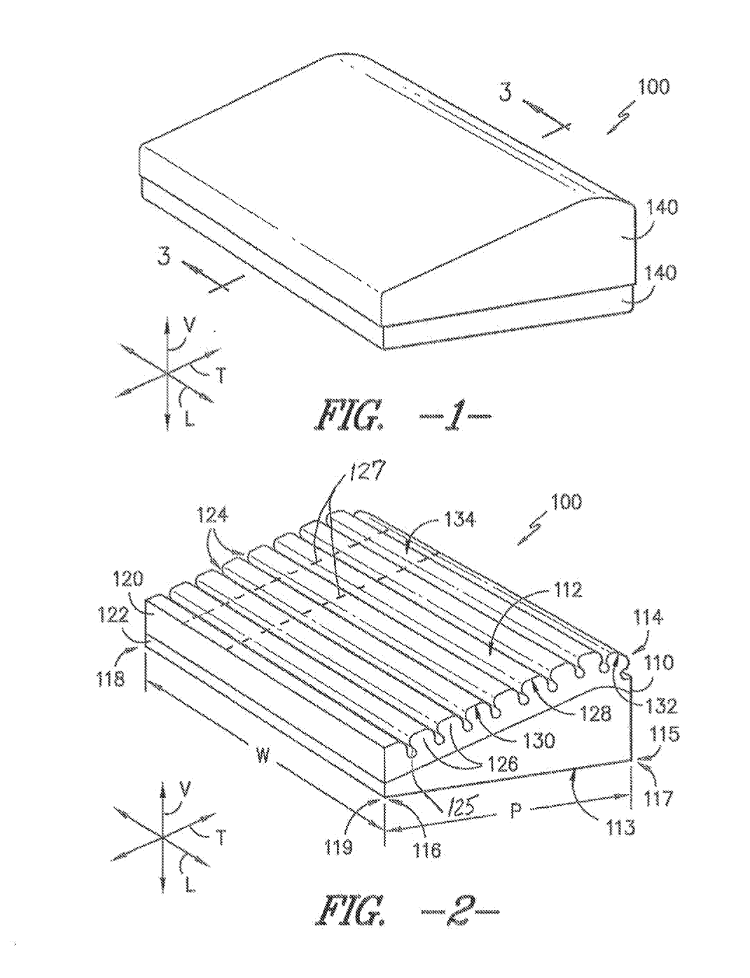

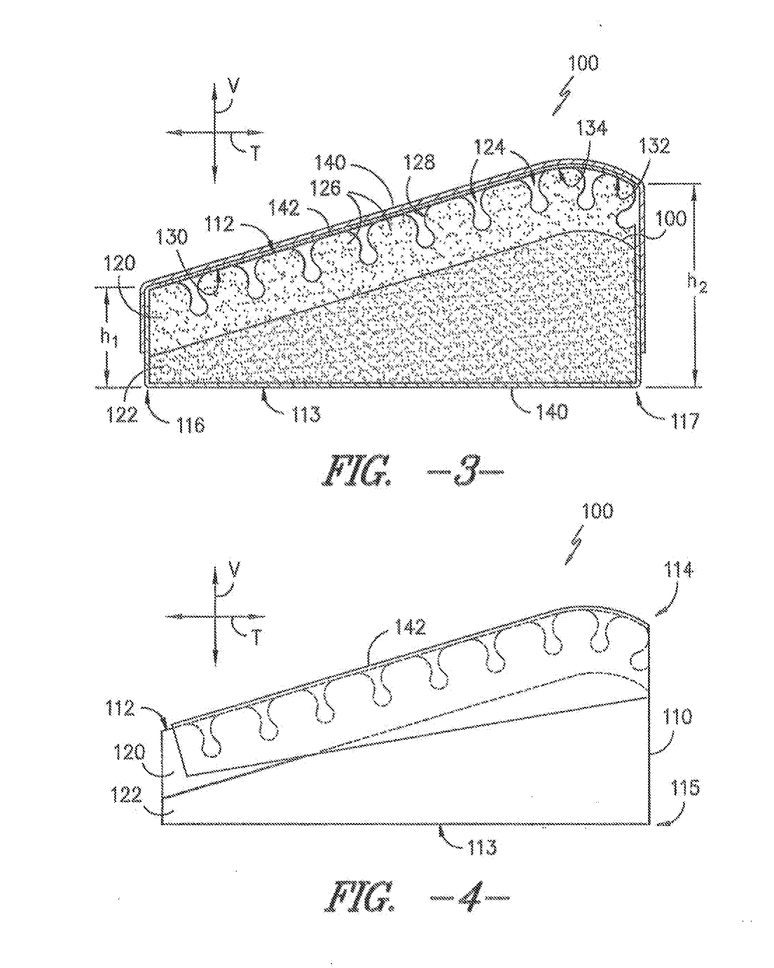

FIG. 1 provides a perspective view of a heel elevating positioner or support generally 100 according to an exemplary embodiment of the presently disclosed subject matter. FIG. 2 provides a perspective view of heel elevating positioner 100 with an outer shell or cover 140 of heel elevating positioner 100 removed to reveal a foam block 110 of heel elevating positioner 100. Heel elevating positioner 100 defines a vertical direction V, a lateral direction L, and a transverse direction T. The vertical direction V, lateral direction L, and transverse direction T are mutually perpendicular and form an orthogonal direction system.

Heel elevating positioner 100 is configured for supporting a leg thereon. As an example, heel elevating positioner 100 can rest on a hospital bed (a patient main support surface), and a patient can rest his or her leg on heel elevating positioner 100, e.g., in order to assist healing or treatment of the same. Heel elevating positioner 100 can improve circulation within legs supported thereon and, as discussed in greater detail below, includes features for hindering or preventing an associated foot from dropping or rotating while supported thereon.

Foam block 110 has a substantially triangular or quadrilateral cross-sectional area in a plane that is perpendicular to the lateral direction L. In particular, foam block 110 is generally but not exactly wedge shaped, in order to assist with elevating and positioning legs thereon.

Foam block 110 extends between a top portion 114 and a bottom portion 115 thereof along the vertical direction V. Foam block 110 also extends between a first end portion 116 and a second end portion 117 thereof along the transverse direction T. In particular, foam block 110 has a length P along the transverse direction T, between first and second end portions 116 and 117. Length P can be any suitable length. For example, length P can be between about five inches and about thirty inches, between about ten inches and about twenty-five inches, or between about fifteen inches and about twenty inches.

Foam block 110 further extends between a first side portion 118 and a second side portion 119 thereof along the lateral direction L. In particular, foam block 110 has a width W along the lateral direction L, between first and second side portions 118 and 119. Width W can be any suitable width. For example, width W can be between about six inches and about fifty inches, between about twelve inches and about forty-eight inches, or between about twenty-four inches and about thirty-six inches.

Foam block 110 has a top surface 112 and a bottom surface 113 thereof positioned on opposite sides of foam block 110. In particular, top surface 112 is positioned adjacent top portion 114 of foam block 110 and bottom surface 113 is positioned adjacent bottom portion 115 of foam block 110. Thus, top surface 112 and bottom surface 113 are spaced apart from each other along the vertical direction V. Top surface 112 is configured for supporting a leg thereon.

As an example, a patient in a bed can utilize heel elevating positioner 100 to elevate his or her leg. In particular, the patient can arrange heel elevating positioner 100 such that bottom surface 113 of foam block 110 is resting on the bed and top surface 112 of 110 is facing upwardly. In such a position, the patient can rest his or her leg on heel elevating positioner 100, e.g., on top surface 112 of foam block 110, as discussed in greater detail below.

Foam block 110 may be constructed of any suitable material. For example, foam block 110 may be constructed of open or closed cell polyethylene foam, open or closed cell polyurethane foam, memory foam, latex foam or combinations thereof. As may be seen in FIG. 1, cover 140 may be positioned over foam block 110. Cover 140 can assist with hindering soiling (protecting) of foam block 110, e.g., when foam block 110 is constructed of an open cell foam, and assist with keeping foam block 110 clean. Cover 140 can rest on top surface 112 of foam block 110 and limit or prevent liquids and/or solids from passing therethrough onto foam block 110. Cover 140 can be a single integral piece or include multiple components. Cover 140 can enclose or surround all of foam block 110 or just a portion of foam block 110. Cover 140 can be constructed of any suitable materials, such as water-resistant or water-proof material. For example, cover 140 may be constructed of cotton, polyester, coated nylon, or polyurethane.

In the exemplary embodiment shown in FIG. 2, foam block 110 includes a first foam portion 120 thereof, e.g., that defines top surface 112 of foam block 110, and a second foam portion 122 thereof, e.g., that defines bottom surface 113 of foam block 110. Thus, second foam portion 122 is positioned below first foam portion 120 along the vertical direction V. First and second foam portions 120 and 122 can be constructed of the same or different materials. As an example, first foam portion 120 can be constructed of open cell polyurethane, and second foam portion 122 can be constructed of closed cell polyurethane or vice versa. In certain exemplary embodiments, second foam portion 122 of foam block 110 has a greater density than first foam portion 120 of foam block 110. Thus, first foam portion 120 can be softer than second foam portion 122 in order to cradle or cushion a leg supported thereon while second foam portion 122 may tend to prevent excessive vertical movement of the leg.

Foam block 110 also defines a plurality of channels 124, e.g., at top surface 112 of foam block 110. Channels 124 can extend along the lateral direction L between first side portion 118 and second side portion 119 of foam block 110. Channels 124 can assist with cushioning legs supported on top surface 112. For example, channels 124 can assist foam block 110 with deflecting or moving when legs are positioned on top surface 112. Channels 124 may also include enlarged bottoms 125 (see FIG. 2) which enhance air movement in and along such channels, to help move warm air and/or moisture away from a patient's supported body member, for protection of the patient's skin condition. Similarly, as shown by representative dotted line cuts 127, the upper surface or some depth thereof of top surface 112 may optionally include spaced cuts over all or some portion of such surface 112, to further facilitate deflecting movement in such surface for accommodating patient comfort and support.

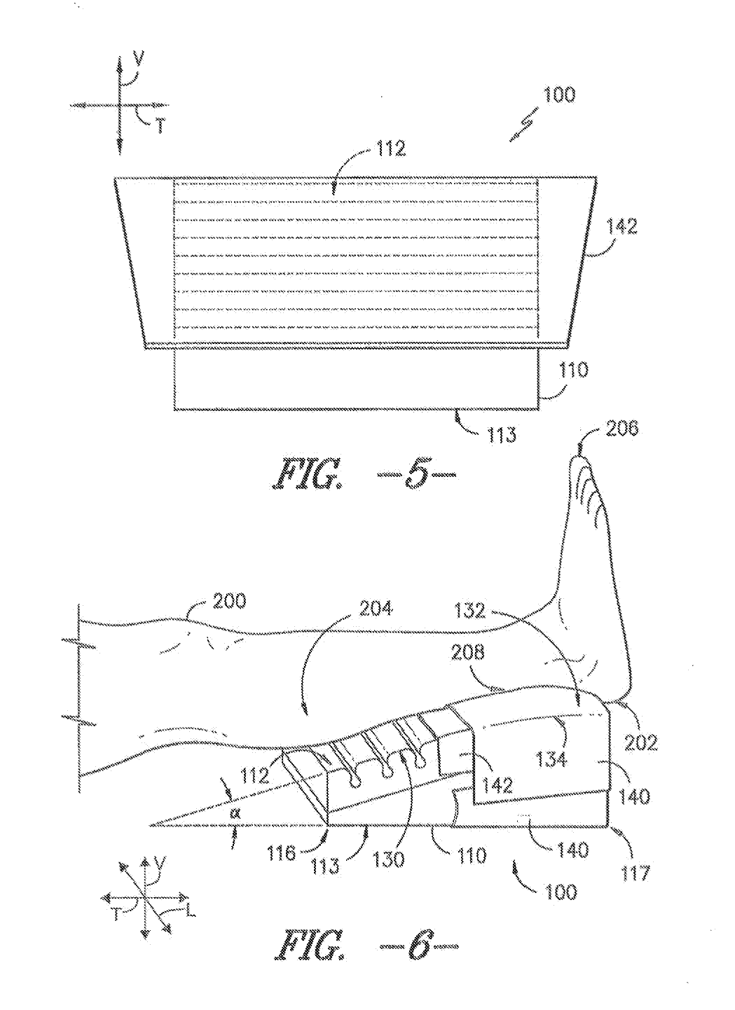

FIG. 3 provides a section view of heel elevating positioner 100 taken along the 3-3 line of FIG. 1. FIG. 4 provides a side, elevation view of heel elevating positioner 100 with cover 140 of heel elevating positioner 100 removed. As may be seen in FIG. 3, first and second end portions 116 and 117 of top surface 112 have respective vertical heights h₁ and h₂, respectively. The second end portion vertical height h₂ can be greater than the first end portion vertical height h₁, e.g., in order to assist with elevating and positioning legs on heel elevating positioner 100. In particular, a foot of a patient can be positioned higher than a calf of the patient on heel elevating positioner 100.

Top surface 112 includes a planar portion 130 positioned adjacent first end portion 116 of foam block 110 and a curved portion 132 positioned adjacent second end portion 117 of foam block 110. Planar portion 130 of top surface 112 and bottom surface 113 define an angle a (FIG. 6) therebetween in a plane that is perpendicular to the lateral direction L. Bottom surface 113 can be perpendicularly oriented relative to the vertical direction V. Thus, planar portion 130 of top surface 112 can be non-perpendicularly oriented or angled relative to the vertical direction V. Angle a can be any suitable angle. For example, angle a can be between about five degrees and about fifty degrees, between about ten degrees and about thirty degrees, between about fifteen degrees and about twenty-five degrees, or about fifteen degrees.

Top surface 112 of foam block 110 also includes a top edge 134, e.g., positioned on curved portion 132 of top surface 112. Top edge 134 is positioned between first end portion 116 of top surface 112 and second end portion 117 of top surface 112 along the transverse direction T. Further, top edge 134 is positioned above, first and second end portions 116 and 117, e.g., along the vertical direction V. Thus, top edge 134 can be the highest portion of foam block 110. Top edge 134 has a curved profile in the plane that is perpendicular to the lateral direction L. Such features can assist with supporting legs on top surface 112 of foam block 110 as discussed in greater detail below.

Foam block 110 also includes a plurality of supports 126 positioned at top surface 112 of foam block 110. Supports 126 extend along the lateral direction L. Each support of supports 126 has a distal end portion 128, e.g., with a substantially semicircular cross-sectional area in a plane that is perpendicular to the lateral direction L. Supports 126 can assist with supporting legs positioned on top surface 112 of foam block 110.

Heel elevating positioner 100 also includes an inner shell or slip (movable internal layer) 142 that can assist a leg resting heel elevating positioner 100 to slide or shift on heel elevating positioner 100, e.g., in the lateral and/or transverse directions L and T, respectively. As may be seen in FIG. 3, slip 142 is disposed between cover 140 and top surface 112 of foam block 110 along the vertical direction V. Slip 142 is configured for reducing shear forces between a leg resting on top surface 112 of foam block 110 and foam block 110 and/or for reducing friction between foam block 110 and cover 140.

FIG. 5 provides a front, elevation view of slip 142 of heel elevating positioner 100 positioned on top surface 112 of foam block 110. Slip or movable internal layer 142 can be constructed of any suitable material. For example, slip 142 can be constructed of low friction materials, such as nylon, silk, or polyester, or other suitable materials, or a fabric coated with a slip agent, any of the foregoing as now existing or later developed.

As referenced above, slip 142 is configured for reducing shear forces between a leg resting on top surface 112 of foam block 110 and foam block 110 and/or for reducing friction between foam block 110 and cover 140. As an example, slip 142 can assist cover 140 with sliding relative to foam block 110, e.g., in the lateral direction L and/or transverse direction T when a leg is positioned thereon. In particular, slip 142 can be constructed of a relatively low friction material, e.g., such that cover 140 can slide (or relatively move) on slip 142 when friction would prevent similar sliding between cover 140 and foam block 110. When cover 140 can slide or move on slip 142 rather than stick to foam block 110, shear stress within a leg sitting on the cover 140 can be reduced as well.

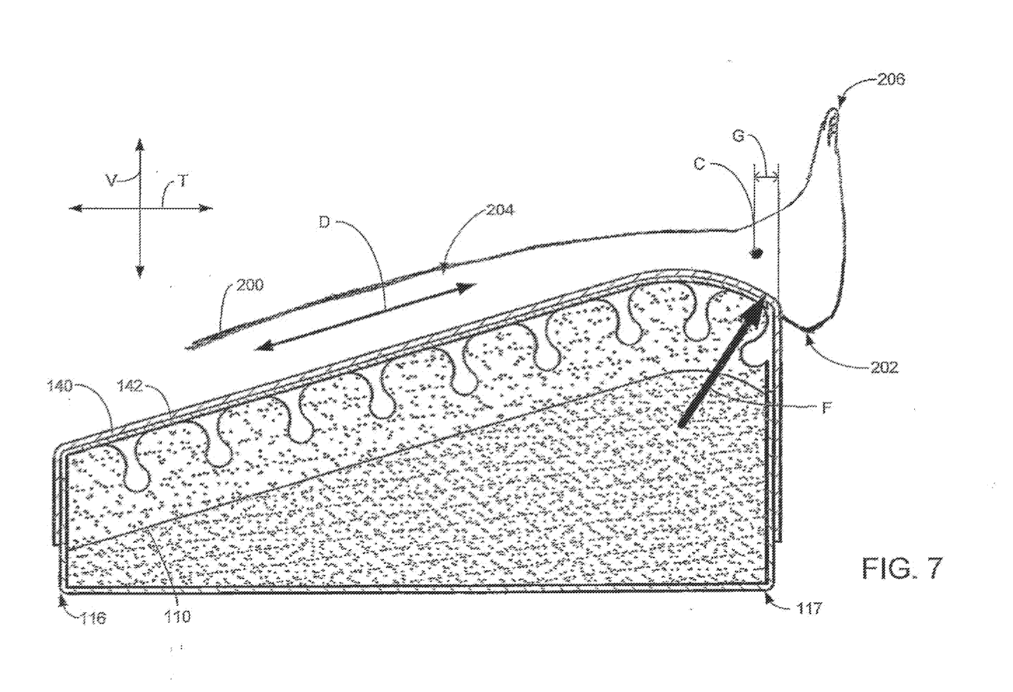

FIG. 6 provides a perspective view of heel elevating positioner 100 with a leg 200 supported thereon. FIG. 7 provides a section view of an exemplary embodiment of a presently disclosed heel elevating positioner generally 100 with representative leg generally 200 supported thereon. As discussed above, heel elevating positioner 100 includes features for opposing downward or forward rotation of a heel supported on foam block 110. In particular, curved portion 132 of top surface 112 and/or top edge 134 of top surface 112 can assist with preventing undesired forward or downward rotation of a heel supported on foam block 110.

As may be seen in FIG. 6, when the leg 200 is supported on heel elevating positioner 100, a heel 202 of the leg 200 is positioned adjacent, e.g., on and/or at, second end portion 117 of foam block 110. Also, an Achilles tendon (not shown but in the area of arrowhead 208) of the leg 200 rests on generally curved portion 132 and/or top edge 134 of top surface 112. Further, a calf 204 of the leg 200 rests on generally planar portion 130 of top surface 112. With leg 200 positioned in such a manner in accordance with the present disclosure, toes 206 of the leg 200 and/or the heel 202 of the leg 200 may be prevented from rotating and/or dropping downwardly along the vertical direction V. In particular, curved portion 132 and top edge 134 are ergonomically shaped to oppose or avoid such forward or downward rotation and drop.

With leg 200 positioned in the manner shown in FIG. 6, Achilles tendon 208 rests on curved portion 132 and top edge 134. As will be understood by those skilled in the art, Achilles tendon 208 is connected to heel 202. Thus, pressure or force applied to Achilles tendon 208, e.g., upwardly along the vertical direction V, can pull on heel 202. Such pulling can cause heel 202 to rotate such that toes 206 drop downwardly along the vertical direction V. However, due to the curved shape of top edge 134 and curved portion 132, Achilles tendon 208 is supported such that heel 202 is not urged to rotate in such direction. In particular, because second end portion 117 of foam block 110 is positioned below top edge 134 along the vertical direction V, heel 202 is supported by second end portion 117 of foam block 110, e.g., without direct contact. As shown in FIG. 7, second end portion 117 of foam block 110 can contact leg 200 at a location above heel 202 and apply a force to leg 200, generally in the direction of force arrow F. As otherwise discussed herein, the location and direction of force F can assist within hindering downward or forward rotation of a patient's foot and toes by tending to raise heel 202 about a pivot point.

Leg 200 has an ankle with a center of rotation or a forward flex point (labeled with point C). As will be understood by those skilled in the art, heel 202 can rotate about the center of rotation C, and such rotation can cause toes 206 to drop downwardly along the vertical direction V (or thought of as “forward” rotation since away from a patient's head end). To oppose such direction of rotation, force F is applied to leg 200 at a location that is spaced apart from center of rotation C, e.g., along the transverse direction T. In particular, second end portion 117 of foam block 110 and center of rotation C are spaced apart from each other, e.g., along the transverse direction T, by a gap G when leg 200 is supported on heel elevating positioner 100 as shown in FIG. 7. Force F can be applied to leg 200 within gap G or between second end portion 117 of foam block 110 and center of rotation C. By applying force F at such a location, undesired downward rotation of heel 202 and dropping of toes 206 can be opposed as will be understood by those skilled in the art from the complete disclosure herewith. It will also be understood by those of ordinary skill in the art from the complete disclosure herewith that the exact location and precise direction of force F can vary from the specific example illustrated while still providing some separation distance G, resulting in the desired opposition to foot drop. Force F can also oppose downward rotation of heel 202 while also opposing formation of pressure ulcers that would occur if pressure were directly applied to heel 202. In particular, force F is applied away from boney protuberances of heel 202 to help protect from the formation of pressure ulcers.

As discussed above, leg 200 can slide on heel elevating positioner 100, e.g., due to slip 142. Slip 142 can permit calf 204 of leg 200 to slide up and down heel elevating positioner 100 along the vertical direction V and/or side to side on heel elevating positioner 100 along the lateral direction L and/or transverse direction T. In particular, calf 204 of leg 200 can slide along a direction D (shown with arrow D in FIG. 7) on heel elevating positioner 100. By permitting such movement of leg 200, slip 142 can assist with reducing shear forces and/or friction between leg 200 and heel elevating positioner 100. In fact, such movement can occur along the direction D, or in a plane formed parallel to the upper support surface of the heel elevating positioner 100.

The present written description uses examples to disclose the presently disclosed subject matter, including the best mode, and also to enable any person skilled in the art to practice the presently disclosed subject matter, including making and using any devices or systems and performing any incorporated methods. While the presently disclosed subject matter has been described in detail with respect to specific embodiments thereof, it will be appreciated that those skilled in the art, upon attaining an understanding of the foregoing may readily adapt the present technology for alterations or additions to, variations of, and/or equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A heel elevating positioner, comprising:
a foam block defining mutually perpendicular vertical, lateral, and circumferential directions, said foam block having a top surface and a bottom surface spaced apart from each other along the vertical direction, and a first end portion and a second end portion on opposite ends of said foam block along the transverse direction thereof;
wherein said top surface comprises a foam support surface for a patient's leg extending between said first and second end portions and along the transverse direction; and
said top surface has a planar portion positioned adjacent the first end portion of the top surface and a curved portion positioned adjacent the second end portion of the top surface, whereby a patient's Achilles tendon is supported along such curved portion while the patient's leg is supported on said planar portion of said support surface to prevent downward rotation of the patient's foot towards said second end portion.

2. A heel elevating positioner as in claim 1, wherein said first and second end portions of the top surface have respective vertical heights, with the vertical height of the second end portion being greater than that of the first end portion.

3. A heel elevating positioner as in claim 1, wherein said top surface of said foam block has a vertical peak on the curved portion of said top surface, with said vertical peak positioned along the transverse direction of said top surface between said first and second end portions.

4. A heel elevating positioner as in claim 1, further comprising a cover received over said foam block.

5. A heel elevating positioner as in claim 4, wherein said cover is constructed of a water resistant material.

6. A heel elevating positioner as in claim 4, further comprising a slip positioned between said cover and said top surface of said foam block along the vertical direction.

7. A heel elevating positioner as in claim 6, wherein said slip is constructed of nylon.

8. A heel elevating positioner as in claim 6, wherein said slip is configured for reducing shear forces between said foam block and a leg resting on the support surface thereof, and for reducing friction between said foam block and said cover.

9. A heel elevating positioner as in claim 1, wherein said foam block defines a plurality of channels at the top surface of said foam block, extending along the transverse direction.

10. A heel elevating positioner as in claim 1, wherein the top surface of said foam block includes a plurality of supports that extend along the transverse direction, each support of the supports having a distal end portion with a substantially semicircular cross-sectional area in a plane that is perpendicular to the transverse direction.

11. A heel elevating positioner as in claim 1, further comprising an additional foam block positioned below and attached to said bottom surface in the vertical direction.

12. A heel elevating positioner as in claim 11, wherein said additional foam block has a different density than that of said foam support surface.

13. A heel elevating positioner, the heel elevating positioner defining a vertical direction, a lateral direction, and a circumferential direction, with such vertical, lateral, and circumferential directions being mutually perpendicular, the heel elevating positioner, comprising a foam block that extends between a first end portion and a second end portion thereof along the transverse direction, said foam block having a top surface that defines a profile in a plane that is perpendicular to the transverse direction, the profile having a linear portion positioned adjacent the first end portion of said foam block and a curved portion positioned adjacent the second end portion of said foam block, whereby a user's leg is supported on said linear portion while an upward support forced is applied to the user's Achilles tendon distal to the pivot point of the user's foot, to prevent downward (or relatively forward) rotation of the user's foot.

14. A heel elevating positioner as in claim 13, wherein the first and second end portions of said top surface have respective vertical heights, the second end portion vertical height being greater than the first end portion vertical height.

15. A heel elevating positioner as in claim 13, wherein the top surface of said foam block has a vertical peak on the curved portion of the top surface, the vertical peak positioned between the first end portion of the top surface and the second end portion of the top surface along the transverse direction.

16. A heel elevating positioner as in claim 13, further comprising a slip positioned over said the top surface of said foam block, with said slip configured for reducing shear forces between said foam block and a patient's leg resting on the top surface thereof.

17. A heel elevating positioner as in claim 16, further comprising a cover mounted over said slip, with said slip further configured for reducing friction between said foam block and said cover.

18. A heel elevating positioner as in claim 13, wherein said foam block defines a plurality of channels at the top surface of said foam block, the channels of the plurality of channels extending along the transverse direction.

19. A method for providing heel elevation while preventing forward rotation of a user's foot and while reducing shear forces applied to the user's heel, comprising:
providing a foam block having a bottom surface, and having a top surface having a planar portion adjacent one end of such top surface and a relatively elevated, curved top edge portion at another end thereof, and with an angle in a range of from about ten degrees to about thirty degrees between the planar portion of the top surface and the bottom surface;
providing a slip layer about the top surface for reducing shear forces between such top surface and a patient's leg received thereon;
providing a cover over such slip layer;
placing the foam block bottom surface on a patient main support surface;
supporting a patient's leg on the top surface of such foam block such that the patient's Achilles tendon of such supported leg is received on the planar portion of the top surface, with a forward flex point of the patient's foot received over such curved top edge portion while the heel of such patient's foot is extending beyond such curved top edge portion, whereby an upward force is applied to the patient's foot to prevent forward rotation thereof.

20. A method as in claim 19, wherein:
the slip comprises low friction material;
the foam block defines a plurality of channels at the top surface thereof; and
the foam block includes a first foam portion that defines the top surface thereof a second foam portion that defines the bottom surface of the foam block, and wherein the second foam portion of the foam block has a greater density than the first foam portion of the foam block.
